(19) United States
(12) Patent Application Publication
(10) Pub. No.: US 2015/0187225 A1
(43) Pub. Date: Jul. 2, 2015

(54) PROVIDING QUIZZES IN ELECTRONIC BOOKS TO MEASURE AND IMPROVE READING COMPREHENSION

(71) Applicant: Google Inc., Mountain View, CA (US)

(72) Inventor: Frank R. Worsley, San Francisco, CA (US)

(21) Appl. No.: 13/726,979

(22) Filed: Dec. 26, 2012

(51) Int. Cl. G09B 17/00

(52) U.S. Cl. CPC G09B 17/003

(57) ABSTRACT

Question material is inserted into an electronic book (“ebook”) by establishing a quiz that corresponds to a portion of the ebook. The quiz comprises one or more questions relating to the portion of the ebook. The quiz is provided a learner client device for presentation to a learner in association with the corresponding portion of the ebook. Learner responses to at least one of the one or more questions are received from the learner client device, the learner responses having been obtained from user input at the learner client device. The learner responses are stored in conjunction with an indication of the corresponding quiz.

### BACKGROUND

1. Technical Field

The subject matter described herein generally relates to the field of electronic books and in particular to the use of electronic books as educational tools.

2. Background Information

Electronic books (“ebooks”) come in a variety of formats (e.g., IDPF/EPUB and PDF) and can be read using a variety of devices (e.g., dedicated reading devices and general-purpose mobile devices, tablet computers, laptop computers, and desktop computers). Each device includes reading software (an “ereader”) that displays an ebook to a user. An ereader that enables a user to interact with an ebook is generally specific to a particular device, a particular ebook format, and/or a particular ebook.

Books have formed an integral part of education for hundreds of years. One aspect of an educator's role is to ensure that students read assigned texts and determine whether they understand the material. In the case of ebooks, technology provides opportunities that are not realized by existing systems to enhance the reading experience of learners and provide educators with tools for analyzing and encouraging learners.

### SUMMARY

The above and other problems are addressed by a method, computer-readable storage medium, and computer for inserting question material into an electronic book (“ebook”). An embodiment of the method comprises establishing a quiz that corresponds to a portion of the ebook, the quiz comprising one or more questions relating to the portion of the ebook. The method also comprises providing the quiz to a learner client device for presentation to a learner in association with the portion of the ebook, and receiving, from the learner client device, learner responses to at least one of the one or more questions, the learner responses obtained from user input at the learner client device. The method further comprises storing the learner responses in conjunction with an indication of the corresponding quiz.

An embodiment of the non-transitory computer-readable storage medium stores executable computer program code for inserting question material into an ebook. The computer program code comprises instructions for establishing a quiz that corresponds to a portion of the ebook, the quiz comprising one or more questions relating to the portion of the ebook. The computer program code also comprises instructions for providing the quiz to a learner client device for presentation to a learner in association with the portion of the ebook, and receiving, from the learner client device, learner responses to at least one of the one or more questions, the learner responses obtained from user input at the learner client device. The computer program code further comprises instructions for storing the learner responses in conjunction with an indication of the corresponding quiz.

An embodiment of the computer system for inserting question material into an ebook includes a non-transitory computer-readable storage medium storing executable computer code. The computer program code comprises instructions for establishing a quiz that corresponds to a portion of the ebook, the quiz comprising one or more questions relating to the portion of the ebook. The computer program code also comprises instructions for providing the quiz to a learner client device for presentation to a learner in association with the portion of the ebook, and receiving, from the learner client device, learner responses to at least one of the one or more questions, the learner responses obtained from user input at the learner client device. The computer program code further comprises instructions for storing the learner responses in conjunction with an indication of the corresponding quiz. The computer system also includes a processor for executing the computer program code.

### BRIEF DESCRIPTION OF THE DRAWINGS

FIG. 1 is a high-level block diagram illustrating an environment for providing quizzes within an ebook in order to measure and improve reading comprehension, according to one embodiment.

FIG. 2 is a high-level block diagram illustrating an example of a computer for use as a repository, a processing server, and/or a client device, according to one embodiment.

FIG. 3 is a high-level block diagram illustrating a question layer module for inserting and presenting a quiz within an ebook, according to one embodiment.

FIG. 4 is a flowchart illustrating a method for presenting a quiz within an ebook, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

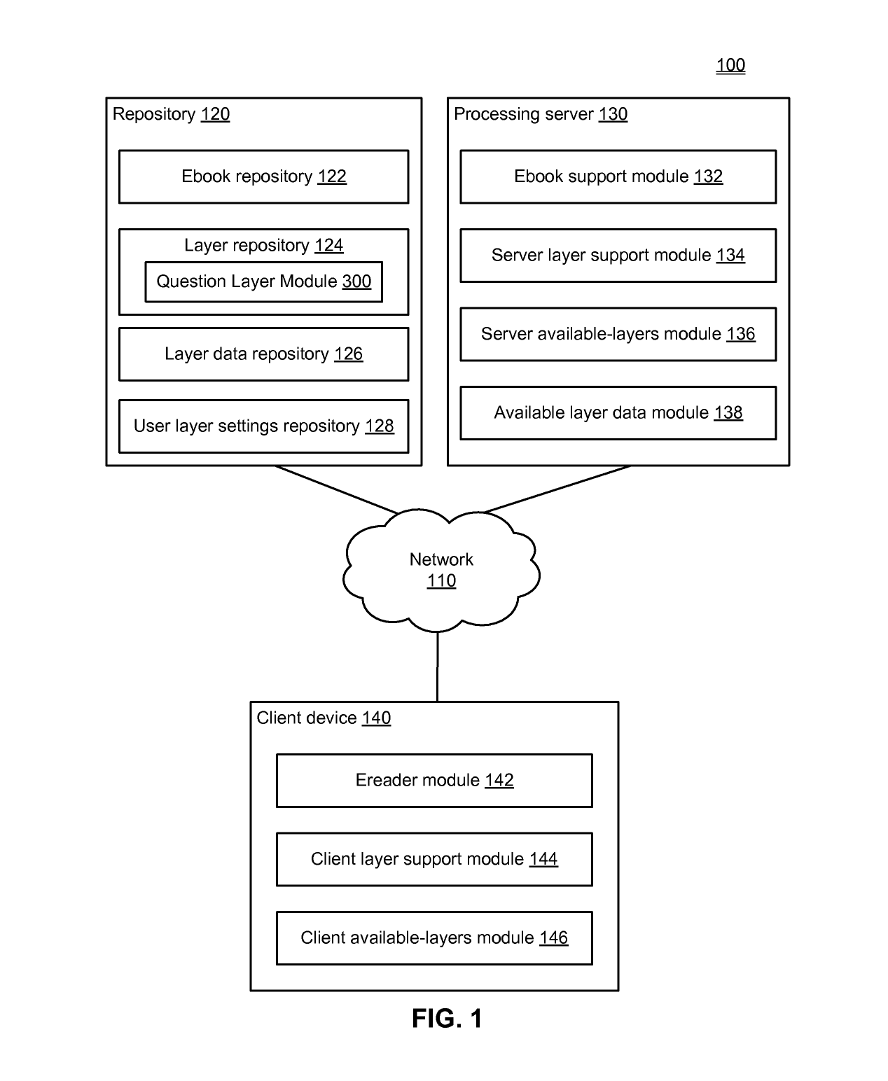

FIG. 1 is a high-level block diagram illustrating an environment 100 for providing a framework for providing quizzes within an electronic book (“ebook”) in order to measure and improve reading comprehension, according to one embodiment. The environment 100 may be maintained by an enterprise that enables interaction with electronic books, such as a corporation, university or other educational institution, or government agency. As shown, the environment 100 includes a network 110, a repository 120, a processing server 130, and a client device 140. While only one of each entity is shown in the embodiment depicted in FIG. 1 for clarity, other embodiments can have multiple repositories 120, processing servers 130, and/or client devices 140. Alternatively, one or more of the entities may be combined and provided by a single computing device. For example, the functionality of the repository 120 and the processing server 130 may be provided by a single server, or group of servers. Further, the functionality attributed to various entities and modules herein may be distributed between entities and modules in a different manner.

The network 110 represents the communication pathway between the repository 120, the processing server 130, and the client device 140. In one embodiment, the network 110 uses standard communications technologies and/or protocols and can include the Internet. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

The client device 140 is used by a user to interact with an ebook. The client device 140 includes an ereader module 142 that enables the user to view the ebook, a client layer support module 144 that enables an ereader tool (“layer”) to be used to interact with the ebook, and a client available-layers module 146 that determines which layers are available to interact with particular ebook content. Other embodiments of the client device 140 include different and/or additional modules. In addition, the functions may be distributed among the modules in a different manner than described herein.

The ereader module 142 enables a user to view and/or read an ebook. The ereader module 142 also communicates with the ebook support module 132 to obtain ebooks that are stored in the ebook repository 122. In one embodiment, the ereader module 142 is a JavaScript program that executes on the client device 140 in conjunction with a web browser (also executing on the client device).

The client layer support module 144 enables a layer to be used to interact with an ebook. The client layer support module 144 also communicates with the server layer support module 134 to obtain layer information that is stored in the layer repository 124 and the layer data repository 126. The client available-layers module 146 determines which layers are available to interact with selected ebook content. Specifically, the client available-layers module 146 takes as input a list of available layers (output by the server available-layers module 136), selected content, and a list of enabled layers and outputs a list of layers that are available for interacting with the selected content. The client available-layers module 146 compares the list of available layers to the list of enabled layers to determine a list of possible layers (i.e., layers that are both available and enabled). The type of the selected content (e.g., text versus image) is then compared to the possible layers (specifically, to the layers' metadata, which specifies what type of ebook content can be interacted with using each layer). The client available-layers module 146 outputs the matching layers as a list. Note that this list of layers is type-of-content-specific.

A layer enhances the functionality of the ereader module 142 by enabling a user to interact with an ebook that is being presented by the ereader module. Specifically, a layer provides additional ebook content and/or functionality and enables a user to interact with particular ebook content. The particular ebook content could be, for example, content that is associated with “layer data” (e.g., user comments relating to other content of the ebook, a type of layer data) or content that the user has activated, where “activated” means indicated in some way, such as by selecting, clicking, tapping, or hovering over. In this way, a layer adds contextually-useful interactivity to the ebook.

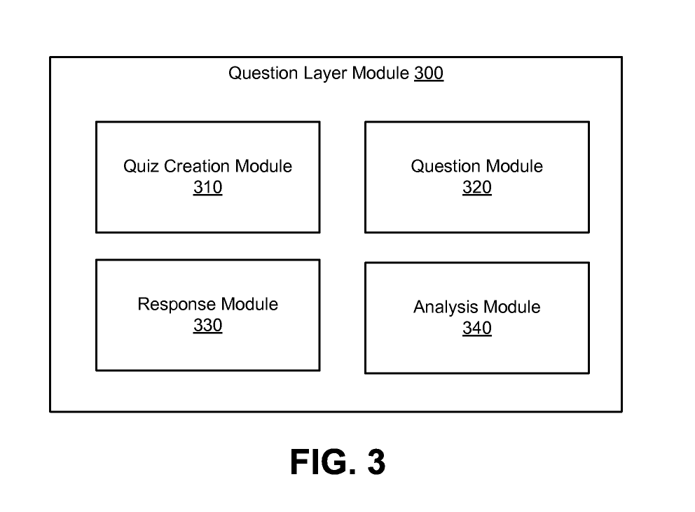

One such layer, referred to herein as a question layer, is used to add question material to an ebook. In one embodiment, the layer also stores learner responses to the provided questions. The question layer may also provide an interface for presenting an analysis of the responses to learners and/or an educator to provide feedback on the progress of the one or more learners. The question layer is described in greater detail below with reference to FIG. 3.

In some embodiments, more than one layer can be used at the same time and/or multiple instances of the same layer can be used at the same time (e.g., for different activated ebook content). Also, multiple layers can display information simultaneously. In another embodiment, layers cannot interact with each other. While multiple layers can be used simultaneously (possibly for the same activated content), the layers cannot access each other's data.

In one embodiment, the client layer support module 144 includes functionality related to enabling/disabling layers, launching layers, indicating the presence of layer data, and providing an application programming interface (API) to layers. Regarding enabling/disabling layers, the client layer support module 144 enables a user to enable/disable layers. Enabled layers can be provided as options in a layer menu (e.g., a popup menu), while disabled layers cannot. Also, layer data (e.g., annotations) associated with enabled layers can be displayed automatically. In one embodiment, a user can designate an enabled layer as “automatic-launch,” which causes the layer to be launched when the ereader module 142 displays ebook content associated with relevant layer data. In another embodiment, a graphical user interface lists “installed” layers (indicated by the user layer settings repository 128), and the user enables/disables these layers (and possibly marks them as “automatic-launch”) by checking/unchecking various boxes. These settings are then stored and made available by the client layer support module 144.

The client layer support module 144 launches a layer (i.e., creates an instance of a layer) so that a layer module is executed by the client device 140. An instance of a layer (e.g., content dynamically rendered by a layer) is displayed within the ereader module's main window or displayed by a separate application (e.g., a web browser invoked with a URL or a map application invoked with an address). In one embodiment, a layer can be displayed in various modes, such as overlay (floating above an entire page of ebook content), replace (floating above particular ebook content, thereby “hiding” the ebook content), side panel (present in a side panel adjacent to the ebook content, possibly in the form of a small preview that can be interacted with), and margin (present in a margin area of the ebook content, possibly in the form of a very limited preview). The ereader module 142 allocates a display area inside of which a layer can create user interface (UI) controls. The ereader module 142 instructs the layer to render itself into the appropriate display area and informs the layer of the context in which it is rendering itself (e.g., overlay, replace, side panel, or margin). The display area that is allocated depends on the layer's display mode. In one embodiment, a layer cannot modify the size of its display area, move the display area, or create UI elements outside of the display area. In another embodiment, a layer can request the properties of its display environment (e.g., display mode, display area size, display area location, and pinning status) and/or be notified of any changes.

Note that layer data must exist on the client device 140 before the layer data can be displayed. However, layer data may include references and/or links to remote content to be accessed via the network 110 and displayed on the client device 140. In one embodiment, layer data is transferred from the repository 120 to the client device 140 (via the processing server 130 and the network 110) in response to a request from the client layer support module 144.

A layer can access the ebook content for which it was launched (e.g., activated content or annotated content) and also a context object. A context object is a data structure that stores information about a particular ebook's context. In one embodiment, the context object includes only context that is local to the ebook and the user's interaction with the ebook. Local context includes, for example, ebook title, author, publisher, indication of currently-displayed portion of ebook (e.g., chapter number and page number), indication of current ebook display mode (e.g., flowing text versus scanned image), and device capabilities. In another embodiment, additional context is provided such as related books, most popular pages in the ebook, etc.

The repository 120 is a computer (or set of computers) that stores an electronic book (“ebook”) repository 122, an ereader tool (“layer”) repository 124, a layer data repository 126, and a user layer settings repository 128. In one embodiment, the repository 120 includes a server that provides the processing server 130 access to the ebook repository 122, layer repository 124, layer data repository 126, and user layer settings repository 128 in response to requests. Other embodiments of the repository 120 include different and/or additional modules. In addition, the functions may be distributed among the modules in a different manner than described herein.

The ebook repository 122 stores a corpus of ebooks. In one embodiment, an ebook adheres to the JavaScript Object Notation (JSON) format. An ebook includes content and metadata. Ebook content includes an electronic collection of text (and possibly additional types of content such as images and/or sound). For example, ebook content includes content of a book such as would be printed on the pages of a traditional paper-based book. All of the text in the collection may be from a single source, or the collection may contain text from different sources. The text may have originated in a traditional paper-based format (e.g., a physical book or newspaper), or it may have originated in a digital format (e.g., electronic files in a format such as Portable Document Format (PDF), EPUB format, or flowing text format). The content of an ebook is divided into segments so that portions of the content can be transferred and/or loaded separately. For example, an ebook can include one segment for each chapter. In one embodiment, ebook content includes files that adhere to the HTML format, the Cascading Stylesheets (CSS) format, and various multimedia formats (e.g., audio files, image files, and video files).

Ebook metadata includes bibliographical information about an ebook, such as the title, author, publication date, number of pages, number of chapters, etc. Ebook metadata also includes a list of segments into which the ebook's content is divided. A segment is represented on the list by, for example, a unique identifier. In one embodiment, ebook metadata also includes a blacklist, a whitelist, and/or an add-list. These lists control which layers can be used with an ebook. A blacklist specifies layers that cannot (i.e., are not allowed to) be used with a particular ebook. A whitelist specifies layers that can (i.e., are allowed to) be used with a particular ebook. An add-list specifies layers that are recommended to be used with a particular book. For example, an ebook publisher can require that a particular ebook be interacted with in accordance with a particular blacklist, whitelist, and/or add-list. A layer is represented on a list by, for example, a unique identifier.

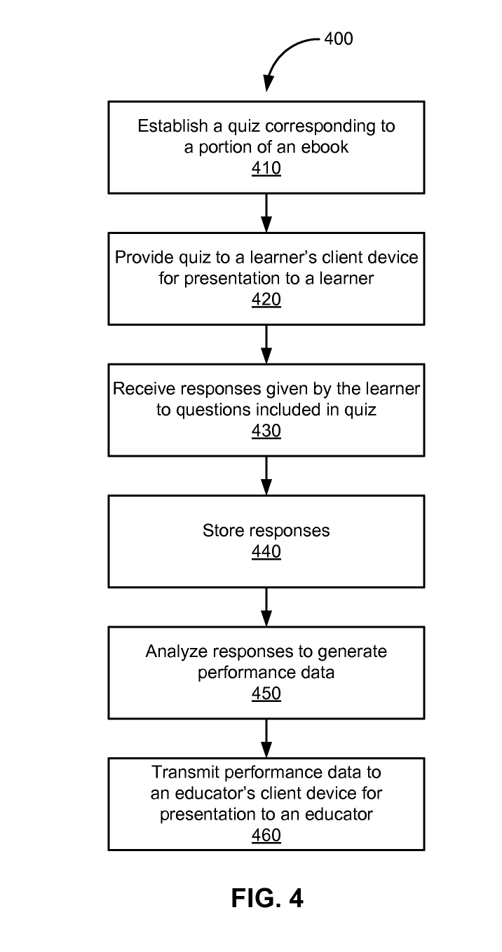

The layer repository 124 stores various layers. As described previously, a layer includes executable code and metadata. A layer provides additional functionality and/or information for an ebook that is being presented by the ereader module 142. Specifically, a layer enables a user to interact with particular ebook content (e.g., content that the user has activated or content that is associated with layer data). The particular content may be text, an image, or other embedded content. In one embodiment, multiple types of content can be activated simultaneously. In one embodiment, a layer module is implemented as a JavaScript program. In the embodiment shown, the layer repository 124 includes a question layer module 300. The question layer module 300 is described below, with reference to FIGS. 3 and 4.

The module of a particular layer must exist on the client device 140 before the layer instance can be launched. In one embodiment, the layer module is transferred from the layer repository 124 to the client device 140 (via the processing server 130 and the network 110) when the client device accesses an ebook that for which that layer is available. In another embodiment, the layer module is transferred if the user has previously requested use of the layer (as indicated in the user layer settings repository 128). In a further embodiment, the layer module is transferred when an attempt is made to launch the layer, either manually (e.g., using a popup menu) or automatically (e.g., based on layer data). For example, the client layer support module 144 detects the attempt and, in response, sends a request to the server layer support module 134 (via the network 110) for the appropriate layer module. The server layer support module 134 receives the request and, in response, sends the requested layer module to the client layer support module 144 (via the network 110). In other embodiments, layer modules are transferred at other suitable times (e.g., when the ereader module 142 is initially installed on the client device 140).

Note that a layer module can already be present on the client device 140 due to having been transferred in the past. In one embodiment, layer modules on the client device 140 are deleted after the ereader module 142 ceases executing. In another embodiment, layer modules remain on the client device 140, even after the ereader module 142 ceases executing. If a layer module remains, the module can be updated later on as necessary (e.g., as indicated by a module version number).

Regarding how a layer is implemented, and how client-side code can execute a layer, in one embodiment, an extensible framework for layers includes the following features: 1) An XML file format for packaging a layer's HTML, JavaScript, and application descriptor into a single file. The application descriptor indicates which types of ebook content the layer is applicable to. 2) A service that renders a layer XML file into HTML/JavaScript that can be displayed in a web browser. 3) Client-side JavaScript for existing web applications (e.g., ereader module 142 and/or client layer support module 144) to instantiate layers and display them inside a container element. The JavaScript creates sandboxed iframe HTML elements for each layer. The iframes use uniform resource locators (URLs) that point back to the service to render the requested layer. 4) Client-side JavaScript for a remote procedure call (RPC) framework that enables applications (e.g., ereader module 142 and/or client layer support module 144) to register JavaScript methods (the Layer API) that the layers can call from their sandboxed iframes. This enables layers to call back into the application and send/receive data. Also, executing a layer in an isolated iframe prevents the layer from interfering with the operation of the ereader module 142.

The layer data repository 126 includes information concerning data that is used by a layer (e.g., to display to the user when the layer is launched). In one embodiment, the data was created by a layer during execution of the layer, (e.g., user responses to questions in a question layer, questions added by an educator, etc.). In another embodiment, the data was created before the layer was ever executed. For example, the creator of a layer that is meant to display study guide text would also create layer data with the actual study guide text. This layer data would exist before the study guide layer was ever executed and would be available to users of the study guide layer.

User layer settings repository 128 includes information concerning which layers a user has “installed.” For example, the user layer settings repository 128 includes, for each user (as indicated by a user ID), a list of layers that user has installed (if any). In one embodiment, the user layer settings repository 128 also includes a default list of installed layers for use with users who are anonymous (e.g., have not logged in). Installation of a layer indicates that the user wants to use that layer at some point in time, although not necessarily all of the time (an installed layer can be disabled). In one embodiment, installation of a layer does not indicate that the module for that layer is actually present on client device 140. Since one person can use multiple devices to read ebooks, user layer settings are stored at the repository 120. If a user wants to use a particular layer on a particular client device 140, the module for that layer will need to be present on that device. In another embodiment, a graphical user interface lists layers that are available for installation. The user installs/uninstalls these layers by checking/unchecking various boxes. These settings are then stored in the user layer settings repository 128.

The processing server 130 is a computer (or set of computers) that executes an ebook support module 132 for handling ebook-related requests, a server layer support module 134 for handling layer-related requests, a server available-layers module 136 for determining which layers are available, and an available layer data module 138 for determining which layer data is available. In one embodiment, the processing server 130 includes a web server that responds to requests from the client device 140. Other embodiments of the processing server 130 include different and/or additional modules. In addition, the functions may be distributed among the modules in a different manner than described herein.

The ebook support module 132 handles ebook-related requests. Specifically, the ebook support module 132 receives requests from the ereader module 142 and responds to them accordingly. One type of request is for ebook metadata. Another type of request is for ebook content.

The server layer support module 134 handles layer-related requests. Specifically, the server layer support module 134 receives requests from the client layer support module 144 and responds to them accordingly. One type of request is for a list of available layers. Another type of request is for layer data.

The server available-layers module 136 determines which layers are available for a specified user to use with a specified ebook. Specifically, the server available-layers module 136 takes as input a user ID and an ebook ID and outputs a list of layers that are available for the user ID to use with the specified ebook. The server available-layers module 136 uses the user ID to determine which layers the user has installed (stored in the user layer settings repository 128). If a user ID is not provided (e.g., the user is anonymous or has not logged in), then a default list of installed layers is used (stored in the user layer settings repository 128).

The server available-layers module 136 uses the ebook ID to determine any layer filtering information such as a blacklist, whitelist, and/or add-list (if any) associated with the ebook (stored in ebook metadata in the ebook repository 122). The server available-layers module 136 then assembles a list of available layers by filtering the list of available layers using the layer filtering information. For example, the filtering may start with the installed layers, keep any layers that are on the whitelist (if a whitelist exists), remove any layers that are on the blacklist and not on the whitelist (if a blacklist exists), and add any layers that are on the add-list (if an add-list exists). If neither a blacklist nor a whitelist nor an add-list exists, then the assembled list includes all of the installed layers. In one embodiment, wildcards can be used in the blacklist, whitelist, and/or add-list. For example, a blacklist that contains only a wildcard would cause all layers to be removed (unless the layers are on the whitelist). The server available-layers module 136 outputs the remaining layers as a list of available layers (including layer metadata such as what type of ebook content a particular layer is applicable to and which display modes are supported by a particular layer). Note that this list of layers is dependent on the specific ebook being accessed by the client device 140.

The available layer data module 138 determines which layer data (e.g., questions) are available for a specified user and specified pages of a specified ebook. In one embodiment, the available layer data module 138 takes as input a user ID, an ebook ID, a content range (e.g., a portion of the ebook), and an indication of which type of layer data is desired and outputs layer data that is available and corresponds to the input. The available layer data module 138 uses the user ID, the ebook ID, and the server available-layers module 136 to determine which layers are available for the specified user to use with the specified ebook. The available layer data module 138 then obtains the layer data (stored in the layer data repository 126) associated with the available layers, the specified user, the specified ebook, and the specified content range. If a user ID is not provided (e.g., the user is anonymous or has not logged in), then the available layer data module 138 obtains the layer data (stored in the layer data repository 126) associated with the available layers, “all users” (e.g., anonymous users or the general public), the specified ebook, and the specified content range. The available layer data module 138 then outputs this layer data.

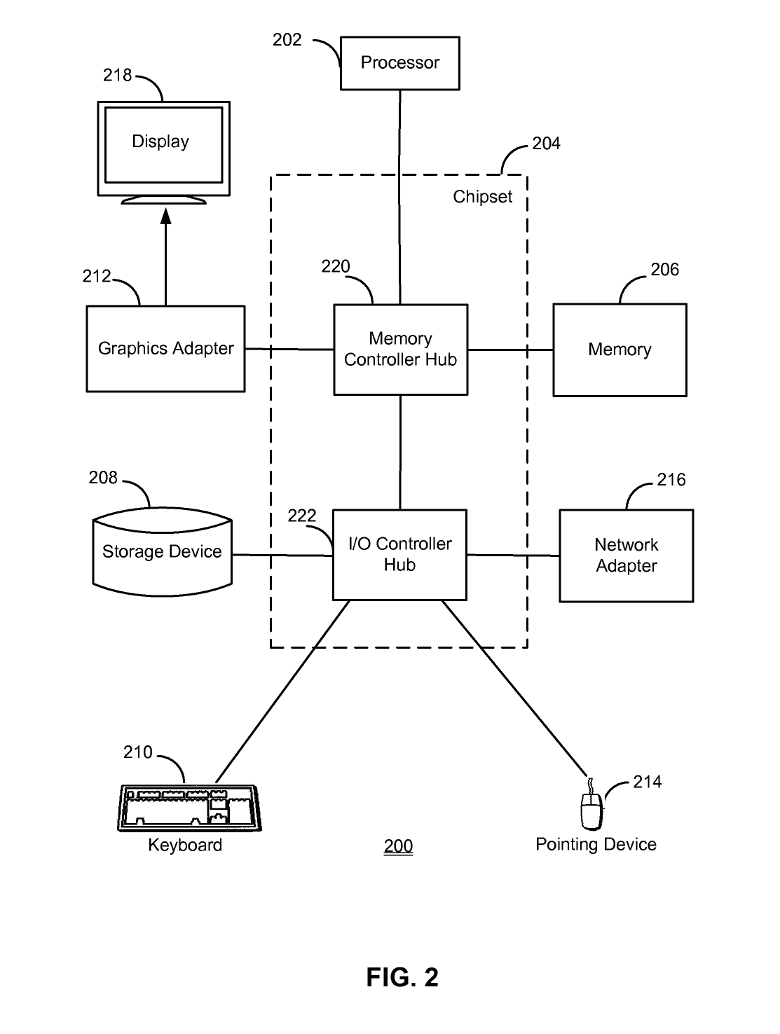

FIG. 2 is a high-level block diagram illustrating an example of a computer 200 for use as a repository 120, a processing server 130, a social network server 150, and/or a client device 140 in accordance with one embodiment. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213. A storage device 208, keyboard 210, pointing device 214, and network adapter 216 are coupled to the I/O controller hub 255. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 213 displays images and other information on the display device 218. In some embodiments, the display device 218 includes a touch screen capability for receiving user input and selections. The network adapter 216 couples the computer system 200 to the network 110. Some embodiments of the computer 200 have different and/or other components than those shown in FIG. 2. For example, the repository 120 and/or the processing server 130 can be formed of multiple blade servers and lack a display device, keyboard, and other components, while the client device 140 can be a notebook or desktop computer, a tablet computer, or a mobile phone.

The computer 200 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

FIG. 3 is a high-level block diagram illustrating a question layer module 300 for inserting and presenting question material in an ebook, according to one embodiment. In one embodiment of the environment 100 (as shown in FIG. 1) the question layer module is stored in a layer repository 124 and provided to the ereader module 142 of a client device 140 by a processing server, via a network 110. The embodiment of the question layer module 300 shown in FIG. 3 includes a quiz creation module 310, a question module 320, a response module 330, and an analysis module 340. Other embodiments of the question layer module 330 include different and/or additional modules. In addition, the functions may be distributed among the modules in a different manner than described herein.

The quiz creation module 310 provides a user interface at the client device 140 for an educator (e.g., a class teacher) to add one or more questions (and in some embodiments, corresponding clues) to a portion of an ebook. A set of questions and corresponding clues (if any) are referred to herein as a “quiz.” The term educator is used herein to refer to a user who has added question material to an ebook. In one embodiment, the educator selects a portion of the ebook (e.g., selecting a chapter in a contents listing, selecting a paragraph with a pointing device, etc.) and the quiz creation module 310 provides a user interface enabling creation of a quiz corresponding to the selected portion. In another embodiment, the educator indicates questions should be added to a portion of an ebook and the quiz is generated automatically by the quiz creation module, based on analysis of the ebook. For example, the quiz creation module 310 can analyze the text of the ebook and determine how many times each of a plurality of entities (people, locations, organizations, objects, etc.) appears in each chapter. The quiz creation module 3100 then generates quiz questions based on the entity analysis, such as “Which of the following characters is chapter 2 about?” The quiz creation module 310 also generates a set of multiple-choice responses consisting of a character that is referred to numerous times in chapter 2 (a correct response) and one or more other characters that appear in the ebook, but not in chapter 2 (incorrect responses). The quiz creation module 310 can also generate questions regarding the relationship entities (e.g., a character and a location) based on reference to both entities in one or more sentences. For example, if a book contains the sentence “Sarah had lived in New York since 2001” the quiz creation module 310 may generate the question “What city does Sarah live in?”

Regardless of how the quiz is generated, it includes one or more questions that correspond to the indicated portion, as well as answers for the one or more questions. In one embodiment, an answer includes a plurality of responses to be presented in multiple-choice form and indicates one or more of the multiple-choice responses to be correct. In another embodiment, the educator provides a model response to which learner answers are compared. Analysis of the responses provided by one or more learners (e.g., students in a class) is described below with reference to the analysis module 340. The term learner is used herein to mean a user reading an ebook that has one or more inserted quizzes. A given user may be both an educator and a learner.

In one embodiment, the educator also optionally provides access permission data, which identifies one or more learners that are authorized to access the quiz. Examples of access permissions data include, but are not limited to: a list of user IDs for learners that are authorized to access the quiz (e.g., students in a class); an indication of a group of learners (e.g., a GOOGLE+CIRCLE™) that is authorized to access the quiz; and/or a password required to access the quiz. If no access permission data is provided, the quiz is considered public and available to all learners. Alternatively, the question layer module 300 can be configured to only allow learners for whom the educator has explicitly granted authorization to access the quiz.

In some embodiments, the user interface provided by the quiz creation module 310 also enables the educator to include clues as part of the quiz. A clue is supplementary content for an ebook that assists learners in answering the questions included in the quiz. A clue can either modify how an element of the ebook is displayed in order to draw attention to that element or be displayed in conjunction with the ebook to provide additional information. For example, the educator could add a highlight effect to a paragraph that contains the answer to a quiz question. As another example, the educator may add additional text and/or images to the ebook that provide additional contextual information to help learners answer the quiz questions. In one such embodiment, the educator can provide access permission data identifying one or more learners that may access the clues independently from the access permission data identifying learners that may access the quiz. Thus, the clues can be tailored to specific target learners. For example, a teacher could provide more clues to a student that finds the subject matter of the quiz difficult, while omitting clues for highly achieving students in order to challenge them.

The quiz creation module 310 sends the educator's user ID, the ebook ID, an indication of the selected portion, and the quiz to the repository 120, via the network 110. The repository 120 stores the user ID, ebook ID, indication of the selected portion, and quiz, along with a quiz ID that uniquely identifies the quiz, in the layer data repository 126. In one embodiment, the quiz ID is generated by the repository 120 based on quiz IDs already present in the layer data repository 126 (e.g., using a consecutive numbering scheme for quizzes). In another embodiment, the quiz creation module 310 uses a Globally Unique Identifier (GUID) algorithm to generate a quiz ID that is guaranteed (or highly likely) to be unique and sends the generated quiz ID to the repository 120 in conjunction with the quiz. The repository 120 then confirms that the quiz ID received does not conflict with a quiz already stored in the layer data repository 126 before storing the received quiz (and sends an error back to the quiz creation module 310 if a quiz ID conflict is detected). In some embodiments, the quiz creation module 310 also sends the access permission data to the repository 120 for storage in the layer data repository 126.

The question module 320 presents quizzes (and any corresponding clues) associated with a portion of an ebook to a learner at a client device 140. The question module 320 sends a request for available quizzes corresponding to a portion of the ebook (up to and including the entire ebook) to the server layer support module 134, via the client layer support module 144 and the network 110. The server layer support module 134 obtains quizzes corresponding to the portion of the ebook and sends the quizzes to the client device 140, via the network 110. In one embodiment, a request for quizzes includes the learner's user ID, the ebook's ebook ID, and an indication of a portion of the ebook for which quizzes are requested.

In one embodiment, the question module 320 requests quizzes corresponding to the portion of the ebook currently displayed by the ereader module 142. In another embodiment, quizzes are requested for a defined portion of the ebook (e.g., a specified page, a specified chapter, or the entire ebook). In a further embodiment, quizzes are downloaded by the ereader module 142 when the ebook is downloaded from the ebook repository 122. Once quizzes have been downloaded to a client device 140, the question module 320 periodically (e.g., every time the ebook is loaded, once a day, etc.) checks the layer data repository 126 for updates to the quizzes. Alternatively, the question module 320 may only check for updates in response to an update request made by the learner.

Having received a quiz, the question module 320 displays the quiz questions and clues (if any) included in the quiz in conjunction with the ebook. In one embodiment, the clues are rendered as overlays on existing pages of the ebook (e.g., in the form of highlighting text from the ebook and/or displaying additional content in margins and other whitespace) while the questions are rendered as additional pages, inserted into the ebook. For example, the questions for a specific chapter may be presented to the learner on a page inserted at the start of the chapter so that learners are aware of what information they are looking for. The questions are then presented again on a page inserted at the end of the chapter and learners prompted to answer the questions. In another embodiment, questions are presented in an overlay which can be toggled between being hidden and viewable. Thus, learners can switch between the ebook and the associated quiz questions at any time. In a further embodiment, the questions are rendered as overlays on existing pages of the book. Thus, learners are forced to read the text closely in order to find all of the questions. At the end of a chapter, the learner may be presented with a page indicating how many questions were found, how many questions were answered correctly, and/or how many questions remain to be found. In other embodiments, the questions and clues are presented in conjunction with the ebook in other manners.

The response module 330 obtains a learner's responses to quiz questions. In one embodiment, the response module 330 provides user interface elements for display in conjunction with the quiz questions to enable the learner to enter responses. For example, the response module 330 can provide radio buttons corresponding to each possible response to a multiple-choice question and/or a text box into which the learner can enter a written response. In one embodiment, the response module 330 sends the learner's user ID, the quiz ID, and the learner's responses to the repository 120, via the network 110. In another embodiment, the responses are stored locally on the client device 140.

In some embodiments, portions of an ebook can be locked until a learner meets unlock criteria, such as completing one or more quizzes and (optionally) achieving at least a threshold score on the one or more quizzes. In one embodiment, the unlock criteria include that a learner is required to answer questions relating to the chapter of a book that the learner has just read to a required standard (e.g., more than a threshold proportion of questions answered, more than a threshold proportion of questions answered correctly, etc.) before being able to proceed to the next chapter. When the learner reaches a point for which there are corresponding questions (e.g., the end of a chapter), the response module 330 polls the layer data repository 126 (e.g., by sending the learner's user ID and a quiz ID) to determine whether the learner has previously met the unlock criteria. If the learner has not previously met the unlock criteria, the question module 320 displays the questions at the client device 140. If the learner has previously met the unlock criteria, then the ereader module 142 proceeds directly to the next chapter. In other embodiments, the learner is given the opportunity to review and/or amend the previously given responses before proceeding to the next chapter, even when the unlock criteria have already been met.

The analysis module 340 analyzes the responses provided by a learner for questions included in a quiz. In embodiments where the quiz comprises multiple-choice questions, the analysis module 340 compares a learner's responses with the correct answers stored in the layer data repository 126 to determine the learner's total score for the quiz. In one embodiment, the questions in a quiz can be weighted by the educator such that some contribute more to the total score than others. In embodiments where the quiz comprises questions that ask for a written response, the analysis module 340 compares the learner's response to the model answer provided by the educator. In some embodiments, a similarity algorithm is applied to the learner's answer to determine how closely it matches with the model answer. In one such embodiment, the analysis module 340 performs a string comparison on the learner's answer to see if the model answer appears. The analysis module 340 may require an exact match, or the answer may appear as a sub-string within the learner's response. In another such embodiment, the analysis module 340 applies a string similarity algorithm to compare the model answer to the learner's answer (e.g., by calculating the Levenshtein distance). In yet another such embodiment, the analysis module 340 applies a phonetic comparison algorithm (e.g., the Soundex algorithm) to determine how closely the learner's response would match the model response if both were spoken aloud. This approach is particularly useful with learners who are not good spellers, such as young children. Alternatively, the learner's responses are sent to the educator (e.g., to an inbox viewable via the user interface provided for the educator by the quiz creation module 310) to be marked. The educator assesses the learner's responses and assigns a score, which is recorded in the layer data repository 126 in conjunction with the learner's responses.

In some embodiments, the analysis module 340 provides an educator dashboard for monitoring the progress of multiple learners, viewable by the educator at a client device 140. The educator dashboard can be presented within the ereader environment or provided separately, such as at a webpage accessed using a web browser executing on the client device 140. The educator dashboard presents the educator with a list of learners in a group taking the educator's quizzes (e.g., a class), information about the progress all such learners, and information about each individual learner's progress. For example, the dashboard can include an indication of the average number of chapters read by learners in the group and an average percentage of questions answered correctly for the group, as well as the number of chapters read and percentage of questions correct for each individual learner. In one embodiment, the educator can define custom groups of learners and view statistics for the group. For example, high school teachers may have two classes reading the same book and want to view statistics regarding all of the students they teach, as well as statistics regarding the performance of each class individually.

In some embodiments, the analysis module 340 provides a learner dashboard for learners to monitor their own progress, viewable by learners at a client device 140. The learner dashboard presents a learner with information about the learner's progress, such as the number of chapters read, the total percentage of questions answered correctly, and a breakdown of the learner's performance by portion of the book (e.g., a percentage of questions answered correctly for each chapter). In one embodiment, the learner dashboard displays the learner's performance relative to other learners (e.g., relative to: the learner's class, the learner's study group, all learners who have taken the quiz, etc.). Learners' performance can be categorized by progress through the book, scores achieved on quizzes, or a combination of both. In a related embodiment, the analysis module 340 ranks all of the learners in a group and presents them in a ladder which can be displayed in the learner dashboard or in the ereader module 142 in conjunction with the ebook (e.g., at the bottom of the ereader display, in place of, or adjacent to, the progress bar). In this way, learners can be encouraged to study through competition. For example, the educator may offer a prize to the learner who tops the ladder each week.

In one embodiment, the functionality attributed herein to the question layer module 300 is split between two different layers, an educator quiz layer and a learner quiz layer (not shown). The educator quiz layer provides the functionality attributed above to the quiz creation module 310 and elements of the analysis module 340 relevant to educators, such as the educator dashboard. The learner quiz layer provides the functionality attributed above to the question module 320 and response module 330, as well as elements of the analysis module 340 relevant to learners, such as the learner dashboard.

FIG. 4 is a flowchart illustrating a method 400 for providing a quiz within an ebook, according to one embodiment. FIG. 4 attributes the steps of the method to a processing server 130. However, some or all of the steps may be performed by other entities. In addition, some embodiments may perform the steps in parallel, perform the steps in different orders or perform different steps.

In the embodiment shown, the method 400 begins with the processing server 130 establishing 410 a quiz that corresponds to a portion of an ebook. The portion of the ebook to which the quiz corresponds can be an entire ebook, a chapter, a page, and the like. In one embodiment, the quiz is established 410 by providing a user interface to a client device 140 of an educator with which the educator creates the quiz, as described above with reference to the quiz creation module 310 of FIG. 3. In another embodiment, the processing server 130 receives an indication of the portion of the ebook from a client device and establishes 410 the quiz by searching the layer data repository 126 for a quiz that corresponds to the indicated portion.

Once the quiz has been established 410, the processing server provides 420 the quiz to a learner client device 140 for presentation to a learner in conjunction with the ebook (e.g., by transmitting the quiz to the learner client device over the network 110). In one embodiment, a preview page and a question page are inserted into the ebook. The preview page includes questions included in the quiz and is inserted immediately prior to the portion of the ebook to which the questions correspond. The question page also includes the questions, but is inserted at the end of the corresponding portion of the ebook, and also prompts the learner to provide responses to the questions. Thus, when a learner is reading the ebook, the ereader module 142 will display a set of questions about a portion of the ebook, then display 430 that portion of the ebook, and then display the questions again and prompt the learner to answer the questions.

If the quiz includes clues, then the processing server 130 provides 420 the clues to the client device 140 such that the ereader module 142 displays the clues in conjunction with the ebook. In one embodiment, the clues include indications of portions of the ebook (e.g., paragraphs) that contain information that will help the learner answer one or more questions. The ereader module 142 emphasizes the indicated portions of the ebook during display, such as applying a visual highlighting effect to the indicated portions, displaying a clue icon next to the indicated portions, and/or providing an audio indicator (e.g., playing a pre-recorded message saying “paragraph 2 is important” when the learner first turns to the page). In another embodiment, the clues include annotations to portions of the ebook that contain additional information and/or hints (e.g., “Remember, the civil war ended in 1865,” “Where has this character been mentioned before?” etc.). The ereader module 142 displays these annotations alongside the corresponding portions of the ebook (e.g., in the nearest margin). If a clue includes audio and/or video content, this content can be played on learner selection, or automatically when the learner turns to the page. In other embodiments, different types of clues are provided and clues are presented to the learner in other ways.

The processing server 130 receives 430 the responses given by the learner to the questions included in the quiz, from the learner's client device 140. In one embodiment, the learner's client device 140 displays the questions at the end of the portion of the ebook to which the questions correspond, and the learner is prompted to provide responses. The responses are obtained from user input by the learner via radio buttons, text boxes, tick boxes, and the like. The precise nature of the input method used to obtain responses depends on the type of response required (e.g., multiple-choice, free-written response, audio recording, image, etc.) and/or preferences set by the educator (e.g., for a multiple-choice question, the educator may select to use radio buttons if selection of only a single possible answer is desired, and tick boxes if selecting more than one answer is appropriate). The learner's client device 140 can transmit (and, therefore, the processing server 130 receive 430) the responses at any appropriate time, including: as the learner provides each response; when the learner selects a “submit responses” control; as part of a regular (e.g., daily, hourly) update; and the like. In other embodiments, responses to questions are obtained from the learner in other manners.

Once the learner's responses have been received 430, the responses are stored 440 along with an indication of the quiz to which the responses correspond. In one embodiment, the ereader module 142 sends the responses to the processing server 130, which then stores 440 the responses in the layer data repository 126, along with the quiz ID that identifies the specific quiz that includes the questions that the responses correspond to. In another embodiment, the responses are stored 440 in local storage of the processing server 130. In other embodiments, the responses are stored 440 in other locations and/or different indications of the corresponding quiz are used. For example, the responses could initially be stored 440 locally on the processing server 130 with an indication of a portion of the ebook to which they correspond (e.g., ebook ID and page number) and later archived in the layer data repository 126 (e.g., after the responses have been analyzed 450, as described below).

The processing server 130 analyzes 450 the responses given by the learner to generate performance data. The performance data can include the learner's individual responses and/or aggregated performance metrics, such as a total score, final grade, attainment level, and the like. In some embodiments, the processing server analyzes 450 responses from multiple learners, such as all learners taking the quiz, or a subset thereof (e.g., a class). Thus, the performance data can include analysis 450 of responses from multiple learners, and the analysis of an individual learner's responses can be based on the responses provided by other learners. For example, the scores assigned to members a class can be normalized based on the performance of the class as a whole.

In one embodiment, the processing server 130 compares the responses given by the learner to a set of correct answers stored in the layer data repository 126, in the manner described above with reference to the analysis module 340 of FIG. 3. In another embodiment, the processing server 130 notifies the educator (e.g., via email, SMS, or the like) that there are question responses ready to be marked. The educator reviews the responses at a client device 140 and provides a corresponding score, grade, or other performance metric for inclusion in the performance data, which is then sent to the processing server 130 via the network 110. In other embodiments, other methods of analyzing 450 the learner's responses are used.

The processing server 130 transmits 460 the performance to the educator's client device 140 for presentation to the educator. In one embodiment, the performance data is presented to the educator via an educator dashboard (either by the ereader module 142, or independently of the ereader environment), as described above with reference to the analysis module 340 of FIG. 3. In other embodiments, the performance data is transmitted 460 to the educator in the form of a report to be viewed outside of the ereader module 142. For example, the educator may be sent an email including the total score for obtained on the quiz by every member of a class. As another example, the results may be transmitted 460 as a data file that can be imported directly into an existing class management and grade tracking application.

In some embodiments, the processing server 130 also transmits some or all of the performance data to learners' client devices 140 so that the learners can track their progress. In one embodiment, the performance data is presented to learners in a learner dashboard, as described above with reference to the analysis module 340 of FIG. 3. In one embodiment, a given learner is presented with a detailed breakdown of the given learner's own performance (e.g., which questions were answered correctly and incorrectly, a total score, and/or a final grade) but the performance of other learners is presented in aggregate only (e.g., an average score for a class etc.). In this way, the privacy of learners, who may not wish others to know how well they are performing, is protected.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process inserting quizzes into an ebook to aid educators in measuring and improving learner comprehension. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

1. A computer-implemented method for inserting question material into an electronic book, comprising:
establishing a quiz responsive to information received from an educator client device, the quiz corresponding to a portion of the electronic book, the quiz comprising one or more questions relating to the portion of the electronic book and quiz access permission data indicating learners authorized to access the quiz;
receiving, from one or more educator client devices, one or more clues to assist one or more learners in responding to the one or more questions, each clue comprising clue content for display and clue access permission data indicating the one or more learners are authorized to access the clue and the quiz, the clue access permission data distinct from the quiz access permission data;
providing the quiz to a learner client device for presentation to a learner in association with the portion of the electronic book, the learner included in the learners indicated by the quiz access permission data;
providing a subset of the one or more clues to the learner client device for presentation to the learner in conjunction with the one or more questions, the subset comprising at least one of the one or more clues that the clue access permission data indicates the learner has permission to access;
receiving, from the learner client device, learner responses to at least one of the one or more questions, the learner responses obtained from user input at the learner client device; and
storing the learner responses in conjunction with an indication of the corresponding quiz.

2. The computer-implemented method of claim 1, further comprising:
providing a layer to the learner client device, the layer including program code executable at the learner client device to display to the learner, within an electronic book reader of the learner client device, the quiz in conjunction with the portion of the electronic book.

3. The computer-implemented method of claim 1, further comprising:
providing the quiz to a second learner client device for presentation to a second learner in association with the portion of the electronic book, the second learner indicated by the quiz access permission data; and
providing a second subset of the one or more clues to the second learner client device for presentation to the second learner in conjunction with the one or more questions, the second subset comprising at least one different clue of the one or more clues that the clue access permission data indicates the second learner has permission to access.

4. The computer-implemented method of claim 1, wherein establishing the quiz comprises:
determining a number of references to each of a plurality of entities in the portion of the electronic book;
generating at least one of the one or more questions based on a computer implemented entity analysis of the portion of the electronic book, the entity analysis based on the number of references to each of the plurality of entities.

5. The computer-implemented method of claim 1, further comprising:
determining whether a number of the received learner responses exceeds a threshold proportion of the one or more questions; and
unlocking a locked portion of the electronic book for the learner client device responsive to the learner responses exceeding the threshold proportion.

6. The computer-implemented method of claim 1, wherein the learner responses include a written response to a question, the method further comprising:
determining whether the written response to the question is correct by applying a similarity algorithm to compare the written response to a stored model answer to the question, the similarity algorithm based on at least one of a string similarity algorithm and a phonetic comparison algorithm; and
determining a score describing progress of the learner responsive to whether the written response to the question is correct.

7. The computer-implemented method of claim 1, wherein the clue access permission data comprises a first indication that a first learner cannot access a first clue and a second indication that a second learner can access the first clue, the first learner being a student identified as highly achieving, and the second learner being identified as lower achieving, relative to the first learner.

8. The computer-implemented method of claim 1, further comprising:
analyzing learner responses for the learner and one or more other learners to generate performance data, the performance data describing the performance of the learner on the quiz relative to the one or more other learners; and
transmitting the performance data to the learner client device for presentation to the learner.

9. A non-transitory computer-readable storage medium storing executable computer program code for inserting question material into an electronic book, the computer program code comprising instructions for:
establishing a quiz responsive to information received from an educator client device, the quiz corresponding to a portion of the electronic book, the quiz comprising one or more questions relating to the portion of the electronic book and quiz access permission data indicating learners authorized to access the quiz;
receiving, from one or more educator client devices, one or more clues to assist one or more learners in responding to the one or more questions, each clue comprising clue content for display and clue access permission data indicating the one or more learners are authorized to access the clue and the quiz, the clue access permission data distinct from the quiz access permission data;
providing the quiz to a learner client device for presentation to a learner in association with the portion of the electronic book, the learner included in the learners indicated by the quiz access permission data;
providing a subset of the one or more clues to the learner client device for presentation to the learner in conjunction with the one or more questions, the subset comprising at least one of the one or more clues that the clue access permission data indicates the learner has permission to access;
receiving, from the learner client device, learner responses to at least one of the one or more questions, the learner responses obtained from user input at the learner client device; and
storing the learner responses in conjunction with an indication of the corresponding quiz.

10. The non-transitory computer-readable storage medium of claim 9, wherein the computer program code further comprises instructions for:
providing a layer to the learner client device, the layer including program code executable at the learner client device to display to the learner, within an electronic book reader of the learner client device, the quiz in conjunction with the portion of the electronic book.

11. The non-transitory computer-readable storage medium of claim 9, wherein the computer program code further comprises instructions for:
providing the quiz to a second learner client device for presentation to a second learner in association with the portion of the electronic book, the second learner indicated by the quiz access permission data; and
providing a second subset of the one or more clues to the second learner client device for presentation to the second learner in conjunction with the one or more questions, the second subset comprising at least one different clue of the one or more clues that the clue access permission data indicates the second learner has permission to access.

12. The non-transitory computer-readable storage medium of claim 9, wherein establishing the quiz comprises:
determining a number of references to each of a plurality of entities in the portion of the electronic book;
generating at least one of the one or more questions based on a computer-implemented entity analysis of the portion of the electronic book, the entity analysis based on the number of references to each of the plurality of entities.

13. The non-transitory computer-readable storage medium of claim 9, wherein the computer program code further comprises instructions for:
determining whether a number of the received learner responses exceeds a threshold proportion of the one or more questions; and
unlocking a locked portion of the electronic book for the learner client device responsive to the learner responses exceeding the threshold proportion.

14. The non-transitory computer-readable storage medium of claim 9, wherein the learner responses include a written response to a question, and the computer program code further comprises instructions for:
determining whether the written response to the question is correct by applying a similarity algorithm to compare the written response to a stored model answer to the question, the similarity algorithm based on at least one of a string similarity algorithm and a phonetic comparison algorithm; and
determining a score describing progress of the learner responsive to whether the written response to the question is correct.

15. The non-transitory computer-readable storage medium of claim 9,
wherein the computer program code further comprises instructions for:
analyzing learner responses for multiple learners to generate performance data, the performance data describing the learners' performance on the quiz; and
transmitting the performance data to an educator client device for presentation to an educator.

16. The non-transitory computer-readable storage medium of claim 9, wherein the computer program code further comprises instructions for:
analyzing learner responses for the learner and one or more other learners to generate performance data, the performance data describing the performance of the learner on the quiz relative to the one or more other learners; and
transmitting the performance data to the learner client device for presentation to the learner.

17. A computer system for presenting inserted question material in an electronic book, comprising:
a non-transitory computer-readable storage medium comprising executable computer program code, the computer program code comprising instructions for:
receiving a quiz, the quiz corresponding to a portion of the electronic book, the quiz comprising one or more questions relating to the portion of the electronic book and quiz access permission data indicating learners authorized to access the quiz;
receiving, from one or more educator client devices, one or more clues to assist one or more learners in responding to the one or more questions, each clue comprising clue content for display and clue access permission data indicating the one or more learners are authorized to access the clue and the quiz, the clue access permission data distinct from the quiz access permission data;
presenting, the quiz to a learner in association with the portion of the electronic book;
presenting, to the learner, the one or more questions and the subset of the one or more clues in conjunction with the one or more questions, the subset comprising at least one of the one or more clues that the clue access permission data indicates the learner has permission to access;
obtaining, from user input by the learner, learner responses to at least one of the one or more questions; and
sending the learner responses to a server in conjunction with an indication of the corresponding quiz; and
a processor for executing the computer program code.

18. The computer system of claim 17, wherein the computer program code further comprises instructions for:
receiving a layer, the layer including program code executable at the computer system to display to the learner, within an electronic book reader of computer system, the quiz in conjunction with the portion of the electronic book.

19. (canceled)

20. (canceled)

21. The method of claim 1, wherein providing the subset of the one or more clues to the learner client device comprises:
determining the subset of the one or more clues to provide to the learner client device based on the learner, the electronic book, and the portion of the electronic book.

22. The method of claim 1, wherein providing the subset of the one or more clues to the learner client device comprises:
providing the subset of the one or more clues to the learner client device responsive to receiving a request for clues from the learner client device.
